(19) United States
(12) Patent Application Publication
(10) Pub. No.: US 2006/0239454 A1
(43) Pub. Date: Oct. 26, 2006

(54) Image forming method and an apparatus capable of adjusting brightness of text information and image information of printing data

(76) Inventor: Jong-min Kwon, Suwon-si (KR)

Correspondence Address: STANZIONE & KIM, LLP, 919 18TH STREET, N.W., SUITE 440, WASHINGTON, DC, 20006, US

(21) Appl. No.: 11/386,752

(22) Filed: Mar. 23, 2006

(30) Foreign Application Priority Data
Apr. 26, 2005 (KR) 2005-34568

(51) Int. Cl. G09C 5/00

(52) U.S. Cl. 380/54

(57) ABSTRACT

An image forming method and an apparatus capable of adjusting brightness of text information and image information of printing data. In the image forming method, printing data is divided into the text information and the image information, brightness values of the text information and the image information are adjusted, and the printing data having the text information and the image information with the adjusted brightness values is printed. Therefore, the printing data can be printed after the brightness values of the text information and the image information of the printing data are adjusted, so that selected information can be emphasized. Also, either the text information or the image information can be omitted from the printing data when printing by adjusting the brightness value accordingly such that toner can be saved.

### CROSS-REFERENCE TO RELATED APPLICATIONS

This application claims the benefit of Korean Patent Application No. 2005-34568, filed on Apr. 26, 2005, in the Korean Intellectual Property Office, the disclosure of which is incorporated herein in its entirety by reference.

### BACKGROUND OF THE INVENTION

1. Field of the Invention

The present general inventive concept relates to an image forming method and an apparatus, and more particularly, to an image forming method and an apparatus such as a copying machine or a printer, which is capable of adjusting a brightness of text information and image information of printing data before the printing data is printed.

2. Description of the Related Art

Image forming apparatuses typically have a brightness adjusting function to adjust the brightness of printing data before the printing data is printed. When the brightness of the printing data is increased, toner can be saved. When the brightness of the printing data is decreased, the printing data can be printed more clearly, although toner consumption increases.

However, since the brightness adjustment is performed on all the printing data including both text information and image information, undesired information cannot be excluded when printing the printing data. Therefore, toner can be wasted.

Further, specific information of the printing data, including the text information or the image information, cannot be emphasized by selectively adjusting the brightness.

### SUMMARY OF THE INVENTION

The present general inventive concept provides an image forming method and apparatus capable of adjusting brightness values of text information and image information of printing data.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing an image forming method to adjust brightness of text information and image information of printing data, the method including dividing printing data into the text information and the image information, adjusting brightness values of the text information and the image information, and printing the printing data having the text and image information with the adjusted brightness values.

The foregoing and/or other aspects of the present general inventive concept are also achieved by providing a method of forming an image in an image forming apparatus, the method comprising dividing print data from a file into a first group of print data and a second group of print data, individually adjusting a brightness value of at least one of the first group of print data and the second group of print data, and forming an image including the first group of print data and the second group of print data according to the adjusted brightness value.

The foregoing and/or other aspects of the present general inventive concept are also achieved by providing a computer readable medium containing executable code to perform an image forming method to adjust brightness of text information and image information of printing data, the medium comprising executable code to divide printing data into the text information and the image information, executable code to adjust brightness values of the text information and the image information, and executable code to print the printing data having the text and image information with the adjusted brightness values.

The foregoing and/or other aspects of the present general inventive concept are also achieved by providing an image forming apparatus capable of adjusting brightness of text information and image information of printing data, the apparatus including a data dividing unit which divides printing data into text information and image information, a brightness adjusting unit which adjusts brightness values of the text information and the image information, and a printing unit which prints the printing data having the text information and the image information with the adjusted brightness values.

The foregoing and/or other aspects of the present general inventive concept are also achieved by providing an image forming apparatus, comprising a dividing unit to divide print data from a file into a first group of print data and a second group of print data, an adjusting unit to individually adjust a brightness value of at least one of the first group of print data and the second group of print data, and an image forming unit to form an image including the first group of print data and the second group of print data according to the adjusted brightness value.

The foregoing and/or other aspects of the present general inventive concept are also achieved by providing an image forming apparatus, comprising a brightness adjustment unit to set a brightness value of text in printing data of a file at a first gray scale value and to set a brightness value of an image in the printing data of the file at a second gray scale value that is different from the first gray scale value.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a flowchart illustrating an image forming method capable of adjusting a brightness of text information and image information of printing data according to an embodiment of the present general inventive concept;

FIG. 2A illustrates an example of printing data including text information and image information;

FIG. 2B illustrates an example of printed data of which image information is adjusted to have a maximum gray-scale value according to an embodiment of the present general inventive concept;

FIG. 2C illustrates an example of printed data of which text information is adjusted to have a maximum gray-scale value according to an embodiment of the present general inventive concept;

FIG. 2D illustrates an example of printed data of which brightness values of text information and image information are individually adjusted according to an embodiment of the present general inventive concept; and

FIG. 3 is a block diagram illustrating an image forming apparatus capable of adjusting brightness of text information and image information of printing data according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

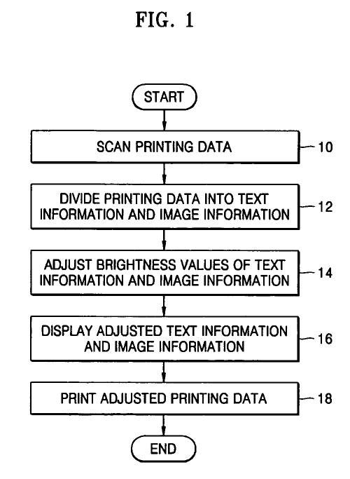

FIG. 1 is a flowchart illustrating an image forming method capable of adjusting a brightness of text information and image information of printing data according to an embodiment of the present general inventive concept.

In operation 10, the printing data may be scanned from a document. For example, a charge-coupled device (CCD) of a copying machine may scan the printing data. CCD-equipped devices such as copying machines may perform this operation, and image forming apparatuses such as printers may not perform this operation. A printer may obtain the printing data from a host device or memory. Thus, when the method of FIG. 1 is performed by a copy machine or scanner, the operation 10 is performed, otherwise the operation 10 may be omitted from the method of FIG. 1.

In operation 12, the printing data is divided into the text information and the image information.

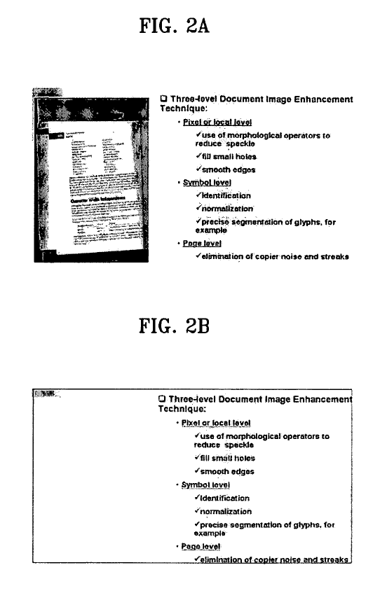

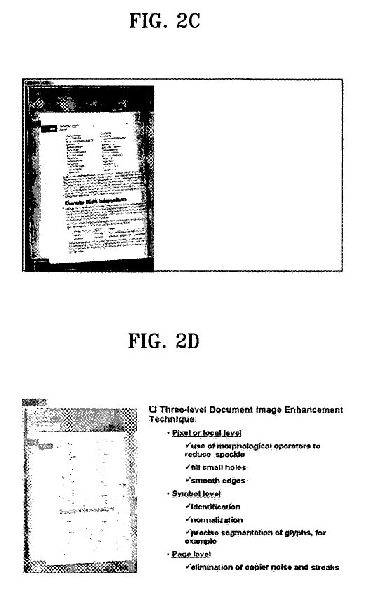

FIG. 2A illustrates an example of printing data including the text information and the image information. Referring to FIG. 2A, when the printing data including the text information and the image information is scanned or input, the printing data is divided into the text information and the image information. Other forms of information not limited to text information and image information can also be obtained from the printing data.

In operation 14, brightness values of the text information and the image information are adjusted.

The text information of the printing data can be adjusted to a maximum gray-scale value. If the gray-scale ranges from 0 to 255, the text information can be adjusted to the maximum gray-scale value of 255. Adjusting the text information to the maximum gray-scale value indicates that the text information will appear white. When the text information is adjusted to the maximum gray-scale value, only the image information can be seen when the printing data is printed (i.e., the printed data).

The image information of the printing data can be adjusted to the maximum gray-scale value. If the gray-scale ranges from 0 to 255, the image information is adjusted to the maximum gray-scale value of 255. Adjusting the image information to the maximum gray-scale value indicates that the image information is treated as white. When the image information is adjusted to the maximum gray-scale value, only the text information can be seen in the printed data (i.e., when the printing data is printed).

In operation 16, the text information and the image information having adjusted brightness values are displayed.

In operation 18, the printing data having the text information and the image information with the adjusted brightness values are printed.

FIG. 2B illustrates an example of the printed data of which the image information is adjusted to have the maximum gray-scale value, FIG. 2C illustrates an example of the printed data of which the text information is adjusted to have the maximum gray-scale value, and FIG. 2D illustrates an example of the printed data of which the brightness values of the text information and the image information are individually adjusted.

When the image information is adjusted to have the maximum gray-scale value, the image information appears white. Thus, when the printing data is printed, only the text information is printed as illustrated in FIG. 2B. When the text information is adjusted to have the maximum gray-scale value, the text information appears white. Thus, when the printing data is printed, only the image information is printed as illustrated in FIG. 2C. In this manner, the text information and the image information can be selectively printed such that toner can be saved. Further, either the text information or the image information can be emphasized by individually adjusting the brightness values of the text information and the image information as illustrated in FIG. 2D.

The image forming method including the operations 10, 12, 14, 16, and 18 may also be embodied as a computer-readable program on a computer-readable recording medium.

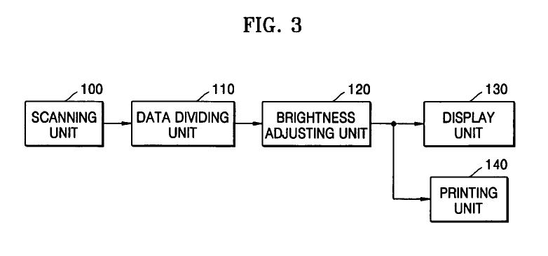

FIG. 3 is a block diagram illustrating an image forming apparatus capable of adjusting a brightness of text information and image information of printing data according to an embodiment of the present general inventive concept. The image forming apparatus may, for example, perform the method of FIG. 1. Referring to FIG. 3, the image forming apparatus includes a scanning unit 100, a data dividing unit 110, a brightness adjusting unit 120, a display unit 130, and a printing unit 140.

The scanning unit 100 scans the printing data and outputs the printing data to the data dividing unit 110. The scanning unit 100 may include a light source to scan a light beam onto an image, a lens to converge the light beam reflected from the image, and an image sensor to receive the converged light. The image sensor may be a charge coupled device (CCD) or a contact image sensor (CIS). The image sensor includes an array of electrical cells which receive the light beam reflected from the image and convert the received light beam into digital image data. The scanning unit 100 may be included in apparatuses such as copying machines and all-in-one machines that perform an image scanning function, but may not be included in image forming apparatuses that do not perform the image scanning function, such as printers. In this case, the scanning unit 100 may be replaced by an input unit. In the image forming apparatuses that do not perform the image scanning function (e.g., printers) the input unit can obtain the printing data from a host device or memory. The printing data obtained from the scanning unit or from the input unit may correspond to a single file.

The data dividing unit 110 divides the printing data scanned by the scanning unit 100 (or obtained from the host device or memory) into the text information (e.g., text objects) and the image information (e.g., image objects) and provides the divided printing data to the brightness adjusting unit 120.

Various text segmentation methods may be used to divide the printing data scanned by the scanning unit 100 into the text information and the image information. For example, a method that uses a red frame of RGB color to obtain high contrast edges for frequent text colors may be used. This method involves using a convolution process with different masks to enhance an image and then detect edges. This edge in the image is further processed by grouping neighboring edge pixels to single connected components structures. Finally, candidates undergo a segmentation process in order to be ready for optical character recognition (OCR).

Another exemplary method performs a color reduction by bit dropping and color clustering quantization, and afterwards a multi-value image decomposition algorithm is applied to decompose an input image into multiple foreground and background images. Then, a connected component analysis is performed on each of the foreground and background images to localize text candidates. This method may tend to extract only horizontal texts of large sizes.

Another exemplary method performs text detection in video, as follows. First, a color image edge detector is used to segment an image. Then, an artificial neural network is used to further classify text blocks and non-text blocks, using features obtained by Gabor filtering. To improve precision of this system, the artificial neural network is trained with every block which is falsely classified as a text block, until desired results are obtained.

Another exemplary method involves scanning an image using a small window of 16×16 pixels, and the image that corresponds to the window is classified as text or non-text using a three-layer neural network, based on local features extracted from high-frequency wavelet coefficients. For a successful detection of various text sizes a three-level pyramid approach may be used. A projection profile analysis may be used to extract text elements (e.g., characters) from text blocks.

Another exemplary method involves an automatic text extraction system which at first uses distinctive characteristics of texts, such as the fact that text possesses certain frequency and orientation information or that characters of a text line show spatial cohesion to identify possible text regions in an image. As a second operation, bottom-up methods may be applied to extract connected components. A simple histogram-based algorithm can automatically find a threshold value for each text region, to be used during a binarization operation.

Another exemplary method involves detecting mainly horizontally aligned texts. Text lines are identified by using a multilayer feed-forward neural network trained to detect text at a fixed scale and position. A gradient image of an input RGB image serves as a feature for text localization. A multi-scale schema is used to detect texts of different sizes. Localized text is scaled to a fixed height and segmented into a binary image.

It should be understood that while various examples of text segmentation methods and/or operations have been provided above, these examples are not intended to limit the scope of the present general inventive concept. Other text segmentation methods may also be used to divide the printing data scanned by the scanning unit 100. Additionally, a combination of these text segmentation methods may also be used.

The brightness adjusting unit 120 adjusts the brightness values of the text information and the image information and outputs the text information and image information having the adjusted brightness values to the display unit 130 and/or the printing unit 140. The brightness adjusting unit 120 may adjust the brightness of the text information to a maximum gray-scale value. If the gray-scale ranges from 0 to 255, the brightness adjusting unit 120 adjusts the text information to have the maximum gray-scale value of 255. Adjusting the text information to the maximum gray-scale value indicates that the text information appears white and will not be discernible when printed.

The brightness adjusting unit 120 can also adjust the brightness of the image information to the maximum gray-scale value. If the gray-scale ranges from 0 to 255, the brightness adjusting unit 120 adjusts the image information to have the maximum gray-scale value of 255. Adjusting the image information to the maximum gray-scale value indicates that the image information appears white and will not be discernible when printed.

The brightness adjusting unit 120 may include one or more buttons (not shown) for the brightness adjustment of the text information and the image information. That is, the brightness adjusting unit 120 may adjust the brightness according to a gray-scale value selected by a user with the one or more buttons.

The display unit 130 displays the text information and the image information having the adjusted brightness values. The display unit 130 may include a liquid crystal display (LCD) or other display mechanism. Additionally, in some embodiments of the present general inventive concept, the user can re-adjust the selected brightness value after viewing the displayed text information and image information.

The printing unit 140 prints the printing data of which the brightness of text information and image information have been adjusted.

The present general inventive concept can be embodied as computer-readable code/instructions/programs and can be implemented in general-use digital computers that execute the code/instructions/programs using a computer-readable recording medium. Examples of the computer-readable recording medium include magnetic storage media (e.g., ROM, floppy disks, hard disks, etc.), optical recording media (e.g., CD-ROMs, or DVDs), and storage media such as carrier waves (e.g., transmission through the internet). Further, the present general inventive concept can be embodied as a computer-readable recording medium having computer-readable code, and the computer-readable recording medium can also be distributed over network-coupled computer systems so that the computer-readable code is stored and executed in a distributed fashion. Also, functional programs, code, and code segments for accomplishing the present general inventive concept can be easily construed by programmers skilled in the art to which the present general inventive concept pertains.

According to the various embodiments of the present general inventive concept, printing data can be printed after brightness values of text information and image information of the printing data are adjusted, so that selected information can be emphasized. Also, either the text information or the image information can be omitted from the printing data when printing by adjusting the brightness value, accordingly, such that toner can be saved.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming method to adjust brightness of text information and image information of printing data, the method comprising:
dividing printing data into text information and image information;
adjusting brightness values of the text information and the image information; and
printing the printing data having the text and image information with the adjusted brightness values.

2. The image forming method of claim 1, further comprising:
scanning the printing data from one or more documents, wherein the dividing of the printing data into the text information and the image information is performed on the scanned printing data.

3. The image forming method of claim 1, wherein the brightness value of the text information is adjusted to a maximum gray-scale value.

4. The image forming method of claim 1, wherein the brightness value of the image information is adjusted to a maximum gray-scale value.

5. The image forming method of claim 1, further comprising:
displaying the text information and the image information having the adjusted brightness values prior to the printing of the printing data.

6. A method of forming an image in an image forming apparatus, the method comprising:
dividing print data from a file into a first group of print data and a second group of print data;
individually adjusting a brightness value of at least one of the first group of print data and the second group of print data; and
forming an image including the first group of print data and the second group of print data according to the adjusted brightness value.

7. The method of claim 6, further comprising:
obtaining the file including the print data from one of a scanning unit, a host device, and a memory.

8. The method of claim 6, wherein the first group of print data comprises image information and the second group of print data comprises text information.

9. The method of claim 6, wherein the adjusting of the brightness value of the at least one of the first group of print data and the second group of print data comprises adjusting a gray scale value of the at least one of the first group of print data and the second group of print data such that one of the first and second groups is emphasized.

10. The method of claim 6, wherein the forming of the image including the first group of print data and the second group of print data comprises:
displaying the image including the first group of print data and the second group of print data on a display unit according to the adjusted brightness value; and
printing the image including the first group of print data and the second group of print data according to the adjusted brightness value.

11. A computer readable medium containing executable code to perform an image forming method to adjust brightness of text information and image information of printing data, the medium comprising:
executable code to divide printing data into text information and image information;
executable code to adjust brightness values of the text information and the image information; and
executable code to print the printing data having the text and image information with the adjusted brightness values.

12. The medium of claim 11, further comprising:
executable code to scan the printing data from one or more documents, wherein the executable code to divide the printing data into the text information and the image information divides the scanned printing data.

13. The medium of claim 11, further comprising:
executable code to display the text information and the image information having the adjusted brightness values prior to the printing of the printing data.

14. An image forming apparatus capable of adjusting brightness of text information and image information of printing data, the apparatus comprising:
a data dividing unit which divides printing data into text information and image information;
a brightness adjusting unit which adjusts brightness values of the text information and the image information; and
a printing unit which prints the printing data including the text and image information having the adjusted brightness values.

15. The image forming apparatus of claim 14, further comprising:
a scanning unit which scans the printing data, wherein the data dividing unit divides the scanned printing data into the text information and the image information.

16. The image forming apparatus of claim 14, wherein the brightness adjusting unit adjusts the brightness value of the text information to a maximum gray-scale value.

17. The image forming apparatus of claim 14, wherein the brightness adjusting unit adjusts the brightness value of the image information to a maximum gray-scale value.

18. The image forming apparatus of claim 14, wherein the brightness adjusting unit includes a button for the brightness adjustment.

19. The image forming apparatus of claim 14, further comprising:
a display unit to display the text information and image information having the adjusted brightness values.

20. The image forming apparatus of claim 19, wherein the display unit comprises an LCD (liquid crystal display) to display the text information and the image information having the adjusted brightness values.

21. An image forming apparatus, comprising:
a dividing unit to divide print data from a file into a first group of print data and a second group of print data;
an adjusting unit to individually adjust a brightness value of at least one of the first group of print data and the second group of print data; and
an image forming unit to form an image including the first group of print data and the second group of print data according to the adjusted brightness value.

22. The apparatus of claim 21, further comprising:
a scanning unit to scan a document to obtain the file including the print data.

23. The apparatus of claim 21, wherein the first group of print data comprises image information and the second group of print data comprises text information.

24. The apparatus of claim 21, wherein the adjusting unit adjusts a gray scale value of the at least one of the first group of print data and the second group of print data such that one of the first and second groups is emphasized in the formed image.

25. The apparatus of claim 21, wherein the image forming unit comprises:
a display unit to display the image including the first group of print data and the second group of print data on a display unit according to the adjusted brightness value; and
a printing unit to print the image including the first group of print data and the second group of print data according to the adjusted brightness value.

26. An image forming apparatus, comprising:
a brightness adjustment unit to set a brightness value of text in printing data of a file at a first gray scale value and to set a brightness value of an image in the printing data of the file at a second gray scale value that is different from the first gray scale value.

27. The apparatus of claim 26, wherein the brightness adjustment unit comprises one or more buttons to receive an input from a user.

28. The apparatus of claim 26, further comprising:
a display unit to display the printing data of the file including the text and the image such that the user adjusts the first and second gray scale values according to the display.

29. The apparatus of claim 26, further comprising:
a dividing unit to divide the printing data into text objects and image objects and to provide the text and image objects to the brightness adjustment unit.

30. The apparatus of claim 26, further comprising:
an input unit to obtain the printing data from one of a scanning operation, a memory, and a host device.
